(19) United States
(12) Patent Application Publication
(10) Pub. No.: US 2014/0268621 A1
(43) Pub. Date: Sep. 18, 2014

(54) Edge Mounting for Printed Circuit

(71) Applicant: Kong-Chen Chen, San Jose, CA (US)

(72) Inventor: Kong-Chen Chen, San Jose, CA (US)

(73) Assignee: Wintec Industries, Inc., Milpitas, CA (US)

(21) Appl. No.: 13/843,961

(22) Filed: Mar. 15, 2013

(51) Int. Cl. H01R 12/73

(52) U.S. Cl. CPC H01R 12/73
USPC 361/803; 174/261; 29/842

(57) ABSTRACT

An electric apparatus is adapted to be electrically coupled to a target platform. The electric apparatus includes a first printed circuit including a first surface parallel to a first plane and a second surface parallel to a second plane perpendicular to the first plane. The first surface has a first area and the second surface has a second area smaller than the first area. A multitude of conductive traces are formed in a layer of the first printed circuit parallel to the first plane. First and second contact regions respectively overlay first and second portions of the second surface. The first and second contact regions are electrically connected to first and second ones of the multitude of conductive traces respectively. The first printed circuit is coupled to the target platform at the first and second contact regions when the first printed circuit is electrically coupled to the target platform.

### BACKGROUND

The present invention relates generally to printed circuits and in particular, to the electrical interface and coupling of the edge surface of one printed circuit to another printed circuit or target platform.

A printed circuit or printed circuit board (PCB) provides electrical connection to components mounted on its surface to achieve a specific function. It is at times more advantageous to provide a smaller PCB, hereinafter also referred to as a “daughter-board”, “module”, or “electric subassembly” for mechanically attaching and electrically interfacing or coupling, hereinafter also referred to as “mounting,” to a larger PCB, hereinafter referred to as “mother-board” or “main-board” or “target platform.” Modules enable system designers to add desired application features and reduce main-board surface area. Typically, mounting a module to the target platform requires providing both mechanical support of the module and connections for multiple electrical signals between the module and target platform. A module may be mounted with its component-carrying surface substantially perpendicular to the component-carrying surface of the target platform, hereinafter also referred to as “vertical mounting”.

Vertical mounting of a module has been provided by plating a set of gold fingers along an edge of the module on opposite sides of the board's component mounting surfaces. The portion of the module with the set of gold fingers may be called a parallel edge connection, for plugging into a corresponding socket on the target platform. Inside the socket, there is a set of fine-pitched parallel springs to make contact with the set of gold fingers on the module. Frequently, the set of fine-pitched parallel springs may suffer spring bending or dislocation due to insertion problems, or surface contamination due to exposure to dust or environmental contamination. Module insertion into the socket may also damage and scratch the surface of the gold fingers. These problems with the parallel edge connection system either on the module or at the socket may lead to failure. Replacing the damaged socket or module is sometimes not an easy task and expensive.

The module may be shaped so that the parallel edge connection fits into a socket in just one orientation, a mechanism called “keying”. The keying is achieved through one or two non-plated notches on module and one or two corresponding insulated bumps inside the socket. Besides the use for orientation identification, the keying is also used to align the positions of gold fingers on a module with the position of springs inside a socket. The accuracy of the keying position impacts insertion accuracy into the socket. Because the springs in the socket are manufactured through a mechanical punch and bending process, a severe limitation is imposed on the distance between two neighboring springs, or the finger pitch, especially if the number of fingers is large. The finest finger pitch for a large finger count socket is about 0.5 mm. It becomes harder to reduce the pin pitch further due to mechanical and manual insertion limitations. Off-the-shelf parallel edge connections and sockets have predetermined finger pitch, which may use up area on the component mounting surface of the module and the main-board and increase system cost. Additionally, the spacing between adjacent sockets is rather large because the width of the socket to support parallel edge connection is large which degrades effective use of the main board area. A solution to support vertical mounting but without these drawbacks of spring mechanical insertion and in parallel edge connection is desired.

### SUMMARY

According to one embodiment of the present invention, an electric apparatus is adapted to be electrically coupled to a target platform. The electric apparatus includes a first printed circuit including a first surface substantially parallel to a first plane and a second surface substantially parallel to a second plane perpendicular to the first plane. The first surface has a first area and the second surface has a second area smaller than the first area. A multitude of conductive traces are formed in a layer of the first printed circuit substantially parallel to the first plane. A first contact region overlays a first portion of the second surface. The first contact region is electrically connected to a first one of the multitude of conductive traces. A second contact region overlays a second portion of the second surface. The second contact region is electrically connected to a second one of the multitude of conductive traces. The first printed circuit is coupled to the target platform at the first and second contact regions when the first printed circuit is electrically coupled to the target platform.

According to one embodiment, the first contact region is coupled to a first circuit node and the second contact region is coupled to a second circuit node different than the first circuit node when the first printed circuit is electrically coupled to the target platform. According to one embodiment, a power and a ground carried on the multitude of conductive traces are coupled from the first printed circuit to the target platform respectively through the first and second contact regions at the second surface of the first printed circuit when the first printed circuit is electrically coupled to the target platform.

According to one embodiment, the first portion of the second surface is substantially planar where the first contact region overlays the second surface. According to one embodiment, the first contact region includes a first width in a first direction substantially parallel to an intersection of the first plane and the second plane. The second contact region includes a second width in the first direction different than the first width.

According to one embodiment, the first printed circuit further includes a conductive layer overlaying a portion of the first surface, the conductive layer disposed adjoining to the first conductive region. The first contact region extends to an edge between the first surface and the second surface, the conductive layer being electrically connected to the first conductive region.

According to one embodiment, the first printed circuit includes a third surface parallel to the first plane. The first contact region extends from an edge between the first surface and the second surface to an edge between the second surface and the third surface.

According to one embodiment, the first printed circuit includes a third surface parallel to the first plane. The first contact region is recessed from an edge between the first surface and the second surface and recessed from an edge between the second surface and the third surface.

According to one embodiment, the first printed circuit includes a solder ball connected to the first conductive region. According to one embodiment, a center of the first contact region and a center of the second contact region are disposed substantially on a line in a direction perpendicular to the first plane.

According to one embodiment, the first contact region is connected to a conductive pin. According to one embodiment, the first contact region includes a conductive membrane layer. According to one embodiment, the first contact region includes an elastic contact. According to one embodiment, the first printed circuit includes a recess in the second surface adapted to align the first printed circuit to the target platform when the first printed circuit is coupled to the target platform.

According to one embodiment, the electric apparatus further includes a second printed circuit including a third surface substantially parallel to the first plane and a fourth surface substantially parallel to the second plane. The third surface has a third area and the fourth surface has a fourth area smaller than the third area. The second printed circuit is coupled to the first printed circuit. A multitude of conductive traces of the second printed circuit is formed substantially parallel to the first plane, and a third contact region overlays a first portion of the fourth surface. The third contact region is electrically connected to a first one of the multitude of conductive traces of the second printed circuit. The second printed circuit is coupled to the target platform at the third and fourth contact regions when the second printed circuit is electrically coupled to the target platform.

According to one embodiment, the electric apparatus further includes at least one conductor adapted to electrically connect a corresponding one of the multitude of conductive traces of the first printed circuit to a corresponding one of the multitude of conductive traces of the second printed circuit. According to one embodiment, the electric apparatus further includes a housing partially enclosing the first and second printed circuits, the housing adapted to mechanically position the first and second printed circuits so as to electrically couple the first and second printed circuits to the target platform when the first and second printed circuits are coupled to the target platform.

According to one embodiment, the electric apparatus further includes a thermally conducting and electrically insulating layer disposed in contact with the first printed circuit and the second printed circuit. According to one embodiment, the electric apparatus further includes a heat dissipater in mechanical contact with the thermally conducting and electrically insulating layer. According to one embodiment, the thermally conducting and electrically insulating layer includes a via adapted to position an interconnect element to connect a corresponding one of the multitude of conductive traces of the first printed circuit to a corresponding one of the multitude of conductive traces of the second printed circuit.

According to one embodiment of the present invention, a method electrically couples a first printed circuit to a target platform. The first printed circuit includes a first surface substantially parallel to a first plane and a second surface substantially parallel to a second plane perpendicular to the first plane. The first surface has a first area and the second surface has a second area smaller than the first area. The first printed circuit further includes a first multitude of conductive traces formed in a layer of the first printed circuit substantially parallel to the first plane. The method includes overlaying a first contact region on a first portion of the second surface of the first printed circuit, and overlaying a second contact region on a second portion of the second surface of the first printed circuit. The method further includes electrically connecting the first contact region to a first one of the first multitude of conductive traces, and electrically connecting the second contact region to a second one of the first multitude of conductive traces. The first printed circuit is coupled to the target platform at the first and second contact regions when the first printed circuit is electrically coupled to the target platform.

According to one embodiment, the method further includes coupling the first contact region to a first circuit node, and coupling the second contact region to a second circuit node different than the first circuit node when the first printed circuit is electrically coupled to the target platform. According to one embodiment, the method further includes coupling a power and a ground on the first multitude of conductive traces from the first printed circuit to the target platform respectively through the first and second contact regions at the second surface of the first printed circuit when the first printed circuit is electrically coupled to the target platform.

According to one embodiment, the method further includes forming the first portion of the second surface to be substantially planar where the first contact region overlays the second surface. According to one embodiment, overlaying the first contact region includes providing a first width in a first direction substantially parallel to an intersection of the first plane and the second plane. The second contact region includes a second width in the first direction different than the first width.

According to one embodiment, the method further includes overlaying a conductive layer on a portion of the first surface adjoining to the first conductive region, and electrically connecting the conductive layer to the first conductive region. Overlaying the first contact region includes extending the first contact region to an edge between the first surface and the second surface.

According to one embodiment, overlaying the first contact region includes extending the first contact region from an edge between the first surface and the second surface to an edge between the second surface and a third surface of the first printed circuit, the third surface being parallel to the first plane. According to one embodiment, overlaying the first contact region includes recessing the first contact region from an edge between the first surface and the second surface and recessing the first contact region from an edge between the second surface and a third surface of the second printed circuit, the third surface being parallel to the first plane.

According to one embodiment, overlaying the second contact region includes disposing a center of the first contact region and a center of the second contact region substantially on a line in a direction perpendicular to the first plane. According to one embodiment, the method further includes connecting a solder ball to the first conductive region. According to one embodiment, the method further includes connecting a conductive pin to the first contact region. According to one embodiment, the method further includes forming a recess in the second surface to align the first printed circuit to the target platform when the first printed circuit is coupled to the target platform.

According to one embodiment, the method further includes coupling a second printed circuit to the first printed circuit. The second printed circuit includes a third surface substantially parallel to the first plane and a fourth surface substantially parallel to the second plane. The third surface has a third area and the fourth surface has a fourth area smaller than the third area. The second printed circuit includes a second multitude of conductive traces formed in a layer of the second printed circuit substantially parallel to the first plane. The method further includes overlaying a third contact region on a third portion of the fourth surface of the second printed circuit, and electrically connecting the third contact region to a first one of the second multitude of conductive traces. The second printed circuit is coupled to the target platform at the third and fourth contact regions when the second printed circuit is electrically coupled to the target platform.

According to one embodiment, coupling includes electrically connecting at least one conductor between a corresponding one of the first multitude of conductive traces of the first printed circuit to a corresponding one of the second multitude of conductive traces of the second printed circuit.

According to one embodiment, the method further includes partially enclosing the first and second printed circuits in a housing, and mechanically positioning the first and second printed circuits with the housing to electrically couple the first and second printed circuits to the target platform when the first and second printed circuits are coupled to the target platform.

According to one embodiment, coupling includes disposing a thermally conducting and electrically insulating layer in contact with the first printed circuit and the second printed circuit. According to one embodiment, coupling includes mechanically connecting a heat dissipater to the thermally conducting and electrically insulating layer. According to one embodiment, the thermally conducting and electrically insulating layer includes a via for positioning an interconnect element connecting a corresponding one of the first multitude of conductive traces of the second printed circuit to a corresponding one of the second multitude of conductive traces of the second printed circuit.

According to one embodiment of the present invention, a method for electrically connecting a printed circuit to a target platform includes forming the printed circuit including a first surface substantially parallel to a first plane and a second surface substantially parallel to a second plane perpendicular to the first plane. The first surface has a first area and the second surface has a second area smaller than the first area. The method further includes forming a multitude of conductive traces in a layer of the printed circuit substantially parallel to the first plane, overlaying a first contact region on a first portion of the second surface of the printed circuit. The method further includes overlaying a second contact region on a second portion of the second surface of the printed circuit, electrically connecting the first contact region to a first one of the multitude of conductive traces, and electrically connecting the second contact region to a second one of the multitude of conductive traces.

According to one embodiment of the present invention, a first electric subassembly is adapted to be electrically connected to a second electric subassembly. The first electric subassembly includes a multitude of planar bases. At least one of the multitude of planar bases includes a first surface substantially parallel to a first plane having a first area, and a second surface substantially parallel to a second plane perpendicular to the first plane, the second surface having a second area smaller than the first area. At least one of the multitude of planar bases further includes a multitude of electrically conductive traces positioned in the first plane, a multitude of regions on the second surface, and a multitude of electrical conductors each being associated with and overlaying a different one of the multitude of regions. The multitude of electrical conductors are each associated with and electrically connected to a different one of the multitude of electrically conductive traces. At least one thermally conducting and electrically insulating layer is disposed between at least a first subset of the multitude of planar bases.

According to one embodiment, each of the multitude of regions is substantially co-planar with the second surface where each of the multitude of electrical conductors overlays the second surface.

A better understanding of the nature and advantages of the embodiments of the present invention may be gained with reference to the following detailed description and the accompanying drawings.

### DESCRIPTION OF THE DRAWINGS

FIG. 1 is a detailed perspective view of a portion of a PCB including a contact region on an edge surface of the printed circuit, in accordance with one embodiment of the present invention.

FIG. 2 is a simplified plan view of a first module including a multitude of the portions of the PCB represented in FIG. 1, in accordance with one embodiment of the present invention.

FIG. 3 is a simplified plan view of a second module including a multitude of the portions of the PCB represented in FIG. 1 including a second PCB with a recess, in accordance with one embodiment of the present invention.

FIG. 4 is a simplified plan view of the second module represented in FIG. 3 mounted vertically on a target platform shown in side view, in accordance with one embodiment of the present invention.

FIG. 5 is a simplified side view of a third module mounted vertically on a main-board shown in side view, in accordance with one embodiment of the present invention.

FIG. 6A is a simplified side view of a fourth module including the printed circuit represented in FIG. 1 including a contact region extending from one component mounting surface of the printed circuit to the opposite component mounting surface and coupled to a conducting trace overlying one of the component mounting surfaces of the printed circuit, in accordance with one embodiment of the present invention.

FIG. 6B is a simplified side view of the module represented in FIG. 6A including a conductive pin, in accordance with one embodiment of the present invention.

FIG. 7A is a simplified side view of a fifth module including a contact region recessed from the corners and overlaying an edge surface of the printed circuit, in accordance with one embodiment of the present invention.

FIG. 7B is a simplified side view of the module represented in FIG. 7A including an elastic contact, in accordance with one embodiment of the present invention.

FIG. 8 is a simplified side view of the module represented in FIG. 7A including a solder ball formed overlying the contact region, in accordance with one embodiment of the present invention.

FIG. 9 is a simplified side view of a sixth module including a multitude of rows of contact regions overlaying an edge surface of the printed circuit, in accordance with one embodiment of the present invention.

FIG. 10 is a simplified perspective view of an assembly of a multitude of attached modules each similar to the module represented in FIG. 2, in accordance with one embodiment of the present invention.

FIG. 11 is a simplified side view of the assembly of a multitude of attached modules similar to those shown in FIG. 10 and mounted to a target platform with a housing, in accordance with one embodiment of the present invention.

### DETAILED DESCRIPTION

A printed circuit, hereinafter also referred to as a printed circuit board (PCB), is a pattern comprising printed wiring formed in a predetermined design in, or attached to, the surface or surfaces of a common base. The base of a printed circuit may include an insulating planar substrate or board formed from a heat resistant resin and reinforcing fiber such as FR4, polyimide, ceramic or other insulating materials. In contrast, semiconductor material forms at least part of the base or substrate of an integrated circuit. The printed circuit may provide electrical connection and mechanical support to an integrated circuit or semiconductor chip mounted on at least one of the two component mounting surfaces of the printed circuit. A printed circuit is thus distinguished from an integrated circuit because the base of a printed circuit does not include a semiconductor material between the two component mounting surfaces of the printed circuit.

The printed wiring is a patterned conductive layer or layers on a surface of and/or within the printed circuit, so as to provide point-to-point, point-to-multipoint, point-to-ground or power plane electric connection and to make electrical connection when electrical components are mounted on a component mounting surface of the printed circuit. It is understood in describing the embodiments of the present invention that the term conductive applies to any material including electrical resistivity less than 10⁻² ohm-cm. It is understood in describing the embodiments of the present invention that the terms connect, connected, and connecting applies to making direct electrical contact or connection between at least two conductive elements without intervening passive or active circuit elements. For example, two conductive elements may be connected by direct mechanical contact, solder, conductive glue, conductive membrane or other conductive material.

The present invention relates generally to printed circuits and in particular, to the electrical interface and coupling of the edge surface of one printed circuit to another printed circuit or target platform. According to an embodiment of the present invention, a multitude of conductive regions, hereinafter also referred to as contact regions, may be formed on an edge surface of a module. The contact regions on the edge surface of the module function as connectors, which facilitate vertical mounting of the module to a target platform and reduce the cost and size of the module and connection system.

FIG. 1 is a detailed perspective view of a portion 100 of PCB 105 including a contact region 110 on an edge surface 120 of the printed circuit, in accordance with one embodiment of the present invention. PCB 105 includes a component mounting surface 130 substantially parallel to a first plane (not shown). The term substantially means within the manufacturing tolerances common to PCBs. Component mounting surface 130 corresponds to one of two surfaces upon which components (not shown) may be mounted to the PCB. Edge surface 120 may be substantially parallel to a second plane (not shown) perpendicular to the first plane. An edge 140, hereinafter also referred to as “corner”, is common to and terminates both edge surface 120 and component mounting surface 130. Component mounting surface 130 has a first area and edge surface 120 has a second area smaller than the first area, because the thickness Tb of PCB 105 is less than the width or depth of the PCB in the first plane.

Contact region 110 overlays a portion of edge surface 120 and may include a width We in a first direction, which is substantially parallel to an intersection of the first plane and the second plane, e.g. in the direction of edge 140 between the edge surface and the component mounting surface. Contact region 110 may include a height Hc in a direction substantially perpendicular to the first plane. The portion of edge surface 120 under contact region 110 may be substantially planar where contact region 110 overlays edge surface 120, which simplifies manufacturing of the module. Consequently, contact region 110 may form a substantially planar contact area. In one embodiment, the material forming the contact region may be a layer of copper or other metal common to printed wiring, similar to conductive composite materials, and/or include a conductive membrane layer. In one embodiment, PCB 105 includes a thickness Tb. Height Hc may be equal to or smaller than thickness Tb. The shape of contact region 110 may include a square, a rectangle, a trapezoid, a circle, an ellipse, or any shape or combination of shapes.

In one embodiment, PCB 105 may include a surface conductive layer 150, which may overlay a portion of component mounting surface 130 disposed adjoining contact region 110. In another embodiment, surface conductive layer 150 may overlay a portion of component mounting surface 130 disposed adjoining and directly connected to contact region 110 at edge 140, the contact region being extended to edge 140 in this case. Surface conductive layer 150 may improve the mechanical and electrical integrity of the connection of PCB 105 to a motherboard (not shown) after mounting. In some embodiments, surface conductive layer 150 may be optional and omitted to free-up area on the component mounting surface.

In one embodiment, PCB 105 may include a conductive trace 170 having a width Wt in the first direction and formed in a layer of PCB 105, which is substantially parallel to component mounting surface 130. Conductive trace 170 may be on a surface of PCB 105, or may be on a layer embedded within PCB 105 (not shown). Conductive trace 170 may be electrically connected directly to contact region 110 or optionally through surface conductive layer 150. PCB 105 may include single-layered printed wiring or multi-layered printed wiring. The conductive trace 170 may carry power, ground, and/or signals to and from contact region 110, which in-turn may carry those signals to an associated contact on the surface of the motherboard or target platform where the module is to be mounted. Contact region 110 is adapted to transfer electricity from conductive trace 170 to the target platform through contact region 110 at edge surface 120 when PCB 105 is electrically coupled to the target platform. In other words, PCB 105 is electrically coupled to the target platform at contact region 110 when PCB 105 is electrically coupled to the target platform. The target platform may be a mother-board, main-board, another module, or a socket or connector mounted on a chassis.

The term coupled means not directly connected but connected through other elements. For example, the PCB may be coupled to the target platform through the contact region and a connector adapted to electrically interconnect the PCB to the target platform. Alternatively, the PCB may be coupled to the target platform through an anisotropic conductive membrane (ACM) positioned at the target platform, or through a conductive membrane or conductive spring at the contact region of the PCB, to facilitate electrical connection between the PCB and the target platform.

FIG. 2 is a simplified plan view of a first module 200 including a multitude of portions 100 of PCB 105 represented in FIG. 1, in accordance with one embodiment of the present invention. FIG. 2 shows first module 200 includes a multitude of the contact regions 110 overlaying edge surface 120 of PCB 105 and further includes a multitude of conductive traces 170 overlaying component mounting surface 130 of PCB 105 of first module 200. Thus, first module 200 is equivalent to the entire portion of PCB 105. Each one of the multitude of conductive traces 170 may be directly electrically connected to associated different ones of the multitude of contact regions 110. Thus, there is at least a second contact region 210 overlaying another portion of edge surface 120. Second contact region 210 may be electrically connected to a second one of the plurality of conductive traces 270. First module 200 is coupled to the target platform at the multitude of contact regions 110 and second contact region 210 when first module 200 is electrically coupled to the target platform. In one embodiment, contact regions 110 may include a width W₁ and the second contact region 210 may include a width W₂ different than the width W₁. In an alternative embodiment W₁ and W₂ may be equal.

FIG. 3 is a simplified plan view of a second module 300 including a multitude of portions 100 of the PCB represented in FIG. 1 including a second PCB 300 with an optional recess 330, in accordance with one embodiment of the present invention. Second module 300 may be similar to first module 200 represented in FIG. 2. Recess 330, shown in FIG. 3, may be a notch, hole, slot, groove or indentation in edge surface 120. Recess 330 in edge surface 120 may be adapted to align second module 300 to the target platform when second module 300 is electrically coupled to the target platform. In other words, recess 330 may be used to facilitate a keying function besides the positional alignment.

FIG. 4 is a simplified plan view of second module 300 represented in FIG. 3 mounted vertically on a target platform 405 shown in side view, in accordance with one embodiment of the present invention. FIG. 4 shows the module is mounted by soldering the multitude of contact regions 110 and the second contact region 210 to a corresponding multitude of contact targets 410 on target platform 405. Solder 460 provides direct electrical connection between associated contact regions 110 and 210 at edge surface 120 of second module 300 and a corresponding multitude of contact targets 410 on target platform 405.

In one embodiment, a module electrical system 470 may be coupled between one of the multitude of contact traces 170 and the second contact trace 270 on PCB 305/second module 300. Module electrical system 470 may include one or more integrated circuit (IC), active and/or passive devices mounted on the component mounting surface of second module 300. The electrical circuit on target platform 405 may complete the circuit connections on second module 300 when the target platform is powered up, forming a completed electrical system 400. Thus, conductive traces 170 and 270 may correspond to different electrical nodes of the module electrical system 470. In other words, one of the multitude of contact regions 110 may be coupled to a first circuit node 170 and the second contact region 210 may be coupled to a second circuit node 270 different than the first circuit node when second module 300 is electrically coupled to target platform 405. In another embodiment, a power and a ground electrical supplies are carried on one of the multitude of conductive traces 170 and conductive trace 270, which are coupled from second module 300 to target platform 405 respectively through the first and second contact regions 110 and 210 at the edge surface of second printed circuit 305, when the module is electrically coupled to the target platform.

In one embodiment, target platform 405 includes an optional keying extension 430 that may be adapted to engage with recess 330 on PCB 305 when module 300 is properly aligned to target platform 405 so that all the contact regions 110 and 210 are properly aligned with the contact targets 410 to the target platform, when module 300 is electrically coupled to target platform 405. To accomplish the alignment, recess 330 may be positioned offset from the center of module 300 so that placement of the module on the target platform will not be made in reverse orientation. If a module is placed with reverse orientation but approximately in the correct location, keying extension 430 would not be able to engage into recess 330, preventing module 300 from being placed in a proper position relative to target platform 405, which would be detectable by placement equipment before module mounting is completed. Keying extension 430 may be implemented by a pin or ridge built into the target platform

Unlike prior art solutions, contact regions 110 and 210 on module 300 eliminate the significant cost added to the module when a discrete prefabricated, off-the-shelf socket is used. Further, module 300 enables the module to be mounted closer to other modules on the main-board's component surface than would be possible in common vertical mounting due to the larger width required by using a parallel edge connection socket on the main-board. Module 300 thus provides a tighter module spacing to fit into systems requiring smaller form factors.

FIG. 5 is a simplified side view of a third module 500 mounted vertically on main-board 405 shown in side view, in accordance with one embodiment of the present invention. Compared to the side view in FIG. 4, the side view in FIG. 5 is rotated 90 degrees about an axis perpendicular to the second plane, i.e. the edge surface plane. FIG. 5 shows solder 560 wicking up optional surface conductive layer 150 on both sides of third module 500 adjoining the edge surface to increase the mechanical strength of the edge mounting installation.

FIG. 6A is a simplified side view of a fourth module 600 including a contact region 610 extending from one component mounting surface of the printed circuit to the opposite component mounting surface and coupled to a conducting trace 170 overlying one of the component mounting surfaces of fourth module 600, in accordance with one embodiment of the present invention. In other words, fourth module 600 includes a second component mounting surface parallel to the first plane and contact region 610 extends from an edge between the first component mounting surface and the edge surface to an edge between the edge surface and the second component mounting surface.

FIG. 6B is a simplified side view of module 600 represented in FIG. 6A including a conductive pin 620, in accordance with one embodiment of the present invention. Conductive pin 620 may be soldered 660 to conductive trace 170 and contact region 610. Conductive pin 620 may include a flattened region 620A that is positioned adjoining conductive trace 170 and another cross sectional region 620B at the opposite longitudinal end of the pin. Region 620B may extend longitudinally in a direction substantially perpendicular to the second plane when conductive pin 620 is attached to module 600 and may be used to mechanically strengthen the mounting of module 600 to the target platform and/or provide a conduction path between module 600 and the target platform and/or provide mechanical keying function.

FIG. 7A is a simplified side view of a fifth module 700 including a contact region 710 recessed from the corners and overlaying an edge surface of the printed circuit, in accordance with one embodiment of the present invention. Fifth module 700 includes a third surface parallel to the first plane, which is the surface of the PCB opposite and parallel to component mounting surface 130 and substantially perpendicular to edge surface 120 as referenced in FIG. 1. FIG. 7A shows contact region 710 is recessed from an edge between component mounting surface 130 and edge surface 120 and recessed from an edge between edge surface 120 and the third surface. According to another embodiment, FIG. 7A also shows an internal conductive trace 770 formed in an internal layer of the PCB, which is substantially parallel to component mounting surface 130. In this example PCB 105 may include multi-layered printed wiring both on the component mounting surface and on a layer embedded within the PCB. Although internal conductive trace 770 is embedded within the PCB, the internal conductive trace may conduct the same types of electrical power, ground and signals and may be used similarly as conductive trace 170. Internal conductive trace 770 may be electrically connected directly to contact region 710 internally through the PCB.

FIG. 7B is a simplified side view of the module represented in FIG. 7A including an elastic contact 710B, in accordance with one embodiment of the present invention. Elastic contact 710B may be attached to contact region 710 and function as a spring contact.

FIG. 8 is a simplified side view of the module represented in FIG. 7A including a solder ball 820 formed overlying contact region 710 overlying the edge surface, in accordance with one embodiment of the present invention. Although the solder ball embodiment is shown in FIG. 8 with contact region 710 and internal conductive trace 770 by way of example, the embodiments of surface or internal conductive trace, recessed contact region, partly recessed contact region (e.g. as shown in FIG. 1), recess, and solder ball overlying contact region may be combined in any combination.

FIG. 9 is a simplified side view of a sixth module 900 including a multitude of rows of contact regions 910 and 915 overlaying an edge surface of the printed circuit, in accordance with one embodiment of the present invention. The multitude of rows of contact regions 910 and 915 may be positioned running substantially parallel to the first direction (i.e. in the direction of edge 140) and overlying the edge surface of the PCB. A center of contact region 910 and a center of contact regions 915 may be disposed or positioned substantially on a line in a direction perpendicular to the first plane or component mounting surface 130. Alternatively, contact regions 910 and 915 may be positioned in any array or random desired relationship to each other so long as each overlays the edge surface of the PCB. FIG. 9 further shows a first internal conductive trace 970 directly connected to contact regions 910 and a second internal conductive trace 975 directly connected to contact regions 915. It is understood that the contact region embodiments are very flexible and may be combined in various combinations with single or multilayer PCB technology to provide a very dense contact interconnect technology at the edge of the PCB.

FIG. 10 is a simplified perspective view of an assembly 1000 of a multitude of attached modules (or PCBs) 1010, 1015, and 1025, coupled electrically or mechanically or coupled both electrically and mechanically to each other, each similar to first module 200 represented in FIG. 2, in accordance with one embodiment of the present invention. FIG. 10 shows at least one or more modules may include contact regions 110 on their respective edge surfaces 120 to accommodate a high number of connectors for connecting the mechanically coupled modules to the target platform. Module 1010 includes a component mounting surface 130 substantially parallel to the first plane and an edge surface 120 substantially parallel to the second plane. The component mounting surface of module 1010 has a third area and edge surface 2070 has a fourth area smaller than the third area. A multitude of conductive traces 170 of module 1010 is formed in a layer of printed circuit 1010 substantially parallel to the first plane. Contact region 120 overlays a portion of edge surface 120 and is directly electrically connected to a first one of the plurality of conductive traces 170 of module 1010. Module 1010 is electrically coupled to the target platform at the contact regions 110 when module 1010 is coupled to the target platform. In one embodiment, module 1010 includes a recess 330, which may facilitate the keying function as described above in reference to FIG. 3.

In one embodiment, a conductor 1020 for connecting signals, power or ground may be embedded between adjacent attached modules. Conductor 1020 may be adapted to electrically connect a corresponding one of the multitude of conductive traces of printed circuit 1015 to a corresponding one of the multitude of conductive traces of printed circuit 2010. In one embodiment, modules 1015 and 1010 may be attached at a few predetermined locations. In one embodiment, modules 1015 and 1010 may be attached substantially continuously using an in-fill or adhesive material across substantially all matching attachment surfaces. The attached modules embodiment may be combined with any of the embodiments described above that facilitate the recess keying function, surface or internal conductive trace, recessed contact region, partly recessed contact region (e.g. as shown in FIG. 1), solder ball overlying contact region, and/or multiple rows of contact regions overlying the edge surface of any one of modules 1010, 1015, and 1025, in any combination.

In one embodiment, a thermally conducting and electrically insulating layer 1095 may be in contact with, sandwiched or disposed between modules 1010 and 1015. In one embodiment, the thermally conducting and electrically insulating layer 1095 may be formed such that a portion of thermally conducting and electrically insulating layer 1095A extends to a surface other than the surface adjacent the component mounting surfaces. Thermally conducting and electrically insulating layer 1095 may be provided to attach modules 1010 and 1015. Thermally conducting and electrically insulating layer 1095 may be an epoxy adhesive with a thermally conducting but electrically insulating filler material such as boron nitride such as 3M™ Thermally Conductive Epoxy Adhesive TC-2810. A heat dissipater 1096 may be placed in contact with thermally conducting and electrically insulating layer 1095A. Heat dissipater 1096 may include a heat sink, a heat pipe, a heat sink with fan, or a thermoelectric cooler, and so on. It is understood that more than two modules may be attached together. In one embodiment, an interconnect element or conductor 1020 may be placed through a via in thermally conducting and electrically insulating layer 1095. The via may be adapted to position an interconnect element to connect a corresponding one of the plurality of conductive traces 170 of module 1010 to a corresponding one of the plurality of conductive traces of module 1015.

Recess 330 may be optional included in any combination. For example, recess 330 may be aligned between all the modules and cut through the thermally conducting and electrically insulating layer 1095 at corresponding locations forming a slot in the edge surface of assembly 1000. The slot in the edge surface of assembly 1000 enables assembly 1000 to engage with a ridge or fin extending out of the target platform when assembly 1000 is mounted, to the target platform to facilitate the keying function as described above.

In one embodiment, a multitude of modules may be attached together forming a compact 3-D module with the plane of the component mounting surfaces on each module positioned substantially perpendicular to the component mounting surface of the target platform when the 3-D module is mounted to the target platform. The thermally conducting and electrically insulating layer and heat dissipater embodiment may be combined with any of the embodiments described above in any combination. In one embodiment, semiconductor chips, other discrete components, or packaged discrete components may be mounted at any of the component mounting surfaces of modules 1015 and 1010.

FIG. 11 is a simplified side view of the assembly 1100 of a multitude of attached modules 1010, 1015, and 1025 similar to those shown in FIG. 10 and mounted to a target platform 1405 with a housing 1130, in accordance with one embodiment of the present invention. FIG. 11 shows assembly 1100 includes the multitude of attached modules 1010, 1015, and 1025 coupled by thermally conducting and electrically insulating layer 1095. Housing 1130 partially encloses assembly 1100. The housing is adapted to mechanically position assembly 1100 so as to electrically couple the multitude of attached modules 1010, 1015, and 1025 to target platform 1405 when assembly 1100 is coupled to the target platform.

In one embodiment, the mechanical positioning of assembly 1100 within housing 1130 is facilitated by interposers 1150A, 1150B, and 1150C positioned between the inner surfaces of housing 1130 and the outer surfaces assembly 1100. In one embodiment, the mechanical positioning of housing 1130 onto target platform 1405 is provided by locking clips 1160 that engage through holes in the target platform to secure housing 1130, assembly 1100 and interposers 1150A, 1150B, and 1150C against target platform 1405 at a position to properly align contact regions 110 on assembly 1100 with contact targets 410 on the target platform. Interposers 1150A, 1150B, and 1150C may be a mechanically elastic material that provides cushioning and/or may be thermally conductive to provide heat dissipation from assembly 1100 to housing 1130, which may also function as a heat radiator.

The above embodiments of the present invention are illustrative and not limiting. Various alternatives and equivalents are possible. Although, the invention has been described with reference to a PCB by way of an example, it is understood that the invention is not limited by the terms board, base, or substrate so long as the base material may be manufactured with a contact region on an edge surface of the base. The embodiments of the present invention are not limited by the size or shape of the contact region. The embodiments of the present invention are not limited by the type of target platform. The embodiments of the present invention are not limited by the size of the printed circuit, the size of the target platform, or the size relationship between the printed circuit and the target platform. The embodiments of the present invention are not limited by types of discrete components connected to the component mounting surface of the printed circuit, such as discrete passive components, microelectronic circuits, semiconductor circuits, other printed circuits or circuit boards, solar panels, thin-film-transistor arrays, and so on. Further, the invention may be used in electrically connecting one printed circuit to another printed circuit or target platform, not limited to permanent or removable electrical connections. Other additions, subtractions, or modifications are obvious in view of the present disclosure and are intended to fall within the scope of the appended claims.

What is claimed is:

1. An electric apparatus adapted to be electrically coupled to a target platform, the electric apparatus comprising:
a first printed circuit including a first surface substantially parallel to a first plane and a second surface substantially parallel to a second plane perpendicular to the first plane, wherein the first surface has a first area and the second surface has a second area smaller than the first area;
a plurality of conductive traces formed in a layer of the first printed circuit substantially parallel to the first plane;
a first contact region overlaying a first portion of the second surface, the first contact region electrically connected to a first one of the plurality of conductive traces; and
a second contact region overlaying a second portion of the second surface, the second contact region electrically connected to a second one of the plurality of conductive traces, wherein the first printed circuit is coupled to the target platform at the first and second contact regions when the first printed circuit is electrically coupled to the target platform.

2. The electric apparatus of claim 1 wherein the first contact region is coupled to a first circuit node and the second contact region is coupled to a second circuit node different than the first circuit node when the first printed circuit is electrically coupled to the target platform.

3. The electric apparatus of claim 1 wherein a power and a ground carried on the plurality of conductive traces are coupled from the first printed circuit to the target platform respectively through the first and second contact regions at the second surface of the first printed circuit when the first printed circuit is electrically coupled to the target platform.

4. The electric apparatus of claim 1 wherein the first portion of the second surface is substantially planar where the first contact region overlays the second surface.

5. The electric apparatus of claim 1 wherein the first contact region includes a first width in a first direction substantially parallel to an intersection of the first plane and the second plane, wherein the second contact region includes a second width in the first direction different than the first width.

6. The electric apparatus of claim 1 wherein the first printed circuit further includes a conductive layer overlaying a portion of the first surface, the conductive layer disposed adjoining to the first conductive region, wherein the first contact region extends to an edge between the first surface and the second surface, the conductive layer being electrically connected to the first conductive region.

7. The electric apparatus of claim 1 wherein the first printed circuit includes a third surface parallel to the first plane, wherein the first contact region extends from an edge between the first surface and the second surface to an edge between the second surface and the third surface.

8. The electric apparatus of claim 1 wherein the first printed circuit includes a third surface parallel to the first plane, wherein the first contact region is recessed from an edge between the first surface and the second surface and recessed from an edge between the second surface and the third surface.

9. The electric apparatus of claim 1 wherein the first printed circuit includes a solder ball connected to the first conductive region.

10. The electric apparatus of claim 1 wherein a center of the first contact region and a center of the second contact region are disposed substantially on a line in a direction perpendicular to the first plane.

11. The electric apparatus of claim 1 wherein the first contact region is connected to a conductive pin.

12. The electric apparatus of claim 1 wherein the first contact region comprises a conductive membrane layer.

13. The electric apparatus of claim 1 wherein the first contact region comprises an elastic contact.

14. The electric apparatus of claim 1 wherein the first printed circuit includes a recess in the second surface adapted to align the first printed circuit to the target platform when the first printed circuit is coupled to the target platform.

15. The electric apparatus of claim 1 further comprising:
a second printed circuit including a third surface substantially parallel to the first plane and a fourth surface substantially parallel to the second plane, wherein the third surface has a third area and the fourth surface has a fourth area smaller than the third area, wherein the second printed circuit is coupled to the first printed circuit;
a plurality of conductive traces of the second printed circuit formed substantially parallel to the first plane; and
a third contact region overlaying a first portion of the fourth surface, the third contact region electrically connected to a first one of the plurality of conductive traces of the second printed circuit, wherein the second printed circuit is coupled to the target platform at the third and fourth contact regions when the second printed circuit is electrically coupled to the target platform.

16. The electric apparatus of claim 15 further comprising at least one conductor adapted to electrically connect a corresponding one of the plurality of conductive traces of the first printed circuit to a corresponding one of the plurality of conductive traces of the second printed circuit.

17. The electric apparatus of claim 15 further comprising a housing partially enclosing the first and second printed circuits, the housing adapted to mechanically position the first and second printed circuits so as to electrically couple the first and second printed circuits to the target platform when the first and second printed circuits are coupled to the target platform.

18. The electric apparatus of claim 15 further comprising a thermally conducting and electrically insulating layer disposed in contact with the first printed circuit and the second printed circuit.

19. The electric apparatus of claim 18 further comprising a heat dissipater in mechanical contact with the thermally conducting and electrically insulating layer.

20. The electric apparatus of claim 18 wherein the thermally conducting and electrically insulating layer comprises a via adapted to position an interconnect element to connect a corresponding one of the plurality of conductive traces of the first printed circuit to a corresponding one of the plurality of conductive traces of the second printed circuit.

21. A method for electrically coupling a first printed circuit to a target platform, the first printed circuit including a first surface substantially parallel to a first plane and a second surface substantially parallel to a second plane perpendicular to the first plane, wherein the first surface has a first area and the second surface has a second area smaller than the first area, wherein the first printed circuit further includes a first plurality of conductive traces formed in a layer of the first printed circuit substantially parallel to the first plane, the method comprising:
overlaying a first contact region on a first portion of the second surface of the first printed circuit;
overlaying a second contact region on a second portion of the second surface of the first printed circuit;
electrically connecting the first contact region to a first one of the first plurality of conductive traces; and
electrically connecting the second contact region to a second one of the first plurality of conductive traces, wherein the first printed circuit is coupled to the target platform at the first and second contact regions when the first printed circuit is electrically coupled to the target platform.

22. The method of claim 21 further comprising:
coupling the first contact region to a first circuit node; and
coupling the second contact region to a second circuit node different than the first circuit node when the first printed circuit is electrically coupled to the target platform.

23. The method of claim 21 further comprising coupling a power and a ground on the first plurality of conductive traces from the first printed circuit to the target platform respectively through the first and second contact regions at the second surface of the first printed circuit when the first printed circuit is electrically coupled to the target platform.

24. The method of claim 21 further comprising forming the first portion of the second surface to be substantially planar where the first contact region overlays the second surface.

25. The method of claim 21 wherein overlaying the first contact region includes providing a first width in a first direction substantially parallel to an intersection of the first plane and the second plane, wherein the second contact region includes a second width in the first direction different than the first width.

26. The method of claim 21 further comprising:
overlaying a conductive layer on a portion of the first surface adjoining to the first conductive region; and
electrically connecting the conductive layer to the first conductive region, wherein overlaying the first contact region includes extending the first contact region to an edge between the first surface and the second surface.

27. The method of claim 21 wherein overlaying the first contact region includes extending the first contact region from an edge between the first surface and the second surface to an edge between the second surface and a third surface of the first printed circuit, the third surface being parallel to the first plane.

28. The method of claim 21 wherein overlaying the first contact region includes recessing the first contact region from an edge between the first surface and the second surface and recessing the first contact region from an edge between the second surface and a third surface of the second printed circuit, the third surface being parallel to the first plane.

29. The method of claim 21 wherein overlaying the second contact region includes disposing a center of the first contact region and a center of the second contact region substantially on a line in a direction perpendicular to the first plane.

30. The method of claim 21 further comprising connecting a solder ball to the first conductive region.

31. The method of claim 21 further comprising connecting a conductive pin to the first contact region.

32. The method of claim 21 wherein the first contact region comprises a conductive membrane layer.

33. The method of claim 21 wherein the first contact region comprises an elastic contact.

34. The method of claim 21 further comprising forming a recess in the second surface to align the first printed circuit to the target platform when the first printed circuit is coupled to the target platform.

35. The method of claim 21 further comprising:
coupling a second printed circuit to the first printed circuit, wherein the second printed circuit includes a third surface substantially parallel to the first plane and a fourth surface substantially parallel to the second plane, wherein the third surface has a third area and the fourth surface has a fourth area smaller than the third area, wherein the second printed circuit includes a second plurality of conductive traces formed in a layer of the second printed circuit substantially parallel to the first plane;
overlaying a third contact region on a third portion of the fourth surface of the second printed circuit; and
electrically connecting the third contact region to a first one of the second plurality of conductive traces, wherein the second printed circuit is coupled to the target platform at the third and fourth contact regions when the second printed circuit is electrically coupled to the target platform.

36. The method of claim 35 wherein coupling includes electrically connecting at least one conductor between a corresponding one of the first plurality of conductive traces of the first printed circuit to a corresponding one of the second plurality of conductive traces of the second printed circuit.

37. The method of claim 35 further comprising:
partially enclosing the first and second printed circuits in a housing; and
mechanically positioning the first and second printed circuits with the housing to electrically couple the first and second printed circuits to the target platform when the first and second printed circuits are coupled to the target platform.

38. The method of claim 35 wherein coupling includes disposing a thermally conducting and electrically insulating layer in contact with the first printed circuit and the second printed circuit.

39. The method of claim 38 wherein coupling includes mechanically connecting a heat dissipater to the thermally conducting and electrically insulating layer.

40. The method of claim 38 wherein the thermally conducting and electrically insulating layer comprises a via for positioning an interconnect element connecting a corresponding one of the first plurality of conductive traces of the second printed circuit to a corresponding one of the second plurality of conductive traces of the second printed circuit.

41. A method for electrically connecting a printed circuit to a target platform, the method comprising:
forming the printed circuit including a first surface substantially parallel to a first plane and a second surface substantially parallel to a second plane perpendicular to the first plane, wherein the first surface has a first area and the second surface has a second area smaller than the first area;
forming a plurality of conductive traces in a layer of the printed circuit substantially parallel to the first plane;
overlaying a first contact region on a first portion of the second surface of the printed circuit;
overlaying a second contact region on a second portion of the second surface of the printed circuit;
electrically connecting the first contact region to a first one of the plurality of conductive traces; and
electrically connecting the second contact region to a second one of the plurality of conductive traces.

42. A first electric subassembly adapted to be electrically connected to a second electric subassembly, the first electric subassembly comprising:
a plurality of planar bases wherein at least one of the plurality of planar bases includes;
a first surface substantially parallel to a first plane having a first area,
a second surface substantially parallel to a second plane perpendicular to the first plane, the second surface having a second area smaller than the first area,
a plurality of electrically conductive traces positioned in the first plane,
a plurality of regions on the second surface, and
a plurality of electrical conductors each being associated with and overlaying a different one of the plurality of regions, the plurality of electrical conductors each being associated with and electrically connected to a different one of the plurality of electrically conductive traces; and
at least one thermally conducting and electrically insulating layer disposed between at least a first subset of the plurality of planar bases.

43. The electric apparatus of claim 42 wherein each of the plurality of regions is substantially co-planar with the second surface where each of the plurality of electrical conductors overlays the second surface.
